(19) United States
(12) Patent Application Publication
(10) Pub. No.: US 2002/0087854 A1
(43) Pub. Date: Jul. 4, 2002

(54) Diskless computer

(76) Inventors: C. Douglas Haigh, Cary, NC (US); Alan D. Dorundo, Boca Raton, FL (US); Chester A. Heath, Boca Raton, FL (US); Kendall A. Honeycytt, Boca Raton, FL (US); Carl Thomson, Delray Beach, FL (US); Ronald Valli, Boca Raton, FL (US); Bart J. Brooks, Boca Raton, FL (US)

Correspondence Address: Kaplan & Gilman, L.L.P., 900 Route 9 North, Woodbridge, NJ, 07095, US

(21) Appl. No.: 09/752,929

(22) Filed: Jan. 2, 2001

Related U.S. Application Data
(60) Provisional application No. 60/247,187, filed on Nov. 10, 2000.

(51) Int. Cl. G06F 9/00

(52) U.S. Cl. 713/1

(57) ABSTRACT

A computer system comprises plural single board computers that utilized shared physical storage. The computers boot from and run applications located remotely. In a preferred embodiment, a hierarchy of such computers is utilized, and the order in which they boot is set such that an optimum sequence is achieved. The computer bus serves as both a network for intercomputer communications, and a bus for intra computer communications.

### RELATED APPLICATION

This application claims priority to and incorporates U.S. Provisional Application 60/247,187.

### TECHNICAL FIELD

This invention relates to computers, and more particularly, to an improved technique of operating a personal computer resident on a single board with no disk storage.

### BACKGROUND OF THE INVENTION

Recently, it has become a goal to eliminate the maintenance and upkeep of many personal computers. The use of disk storage in each computer creates a variety of problems in a typical network office environment. First, the use of a hard disk on each computer may result in different versions of common software applications existing on different computers through the network. Moreover, the total cost of maintaining and managing all of the disks and storage space from the numerous personal computers (PCs) within the network may reach as high as one quarter of the total cost of operation of those PC's over a five year life span of ownership.

Attempts have been made to construct devices which have common disk and disk management for numerous computers on the network. Such a shared disk system results less overhead and maintenance than would be required to maintain all of the hard disks on numerous computers throughout the network.

A network computer, a stripped down version of a personal computer, has become available lately. Unfortunately, the network computer does not solve the problems inherent in prior art systems. More specifically, due to the fact that network computers (NC) connect to the disk with which they communicate over a local area network (LAN), bottlenecks in the network prevent the NCs from operating as efficiently as would be desired. Faster networks are available, but at considerable expense.

In view of the foregoing, there exists a need in the art for an improved technique of implementing a diskless computer in a network environment.

### SUMMARY OF THE INVENTION

It is an object of the invention to provide a system of diskless computers in a network environment wherein all of such computers have access to and full utilization of the hard disk on one of such computers, as well as the other disk based peripherals such as, floppy, CD-ROM, tape, etc.

It is also an object of the invention to provide a method of a computer utilizing an operating system, wherein said operating system is not resident on the local computer.

It is still a further object of the invention to provide a method of loading an operating system initially into a “client” computer from a “host” computer such that a portion of the host disk appears as a disk storing the operating system to the client computer. It is another object of the invention to implement a system with plural computers using a common disk over a network that also serves as a bus.

The above and other problems of the prior art are overcome in accordance with the present invention, which relates to a novel technique for utilizing a remotely stored operating system in a computer network, preferably configured within a single platform. In accordance with the invention, the initial operating system (OS) loader (sometimes termed the boot block) is loaded by a diskless computer's Basic Input Output System (BIOS) from a remote disk over a bus. The bus preferably serves as both a network to interface multiple computers within the single platform, as well as a PC bus to interface each such diskless computer with peripherals to implement bus communications among the various circuit cards that comprise the system.

In accordance with the first embodiment of the invention, the BIOS is stored in read only memory (ROM) and loads the initial OS loader from a remote disk on a different computer, into a predetermined portion of the computer's memory for execution.

In accordance with another embodiment, once the OS loader is loaded into memory, the OS loader loads the remainder of the operating system from the remote disk. The operating system is then configured to load device drivers to manage various future disk access requests.

In still another embodiment, the physical disk with which the computer communicates is subdivided into plural logical disks, each of which may serve as a physical disk for a different remote computer.

In an additional embodiment, a hierarchy is constructed by replacing the physical disk with a virtual disk on a diskless computer that itself accesses a disk on a remote computer.

By providing a high-speed bus, which operates as both a network among computers as well as a bus within each computer, plural computers can take advantage of using the same hard disk as if it were their own. Another advantage is the ability to have different operating systems (OS) on each of the clients and host. This allows for mixed OS environments as well as phased deployed on OS upgrades.

Other advantages and objects of the present invention will become apparent from the following description of the drawings and further embodiments of the invention.

### BRIEF DESCRIPTION OF THE DRAWINGS

FIG. 1 depicts a high level diagram of an exemplary embodiment of the present invention;

FIG. 2 shows software architecture for use in implementing the present invention; and

FIG. 3 shows a hierarchical embodiment of the present invention.

### DETAILED DESCRIPTION OF THE PREFERRED EMBODIMENT

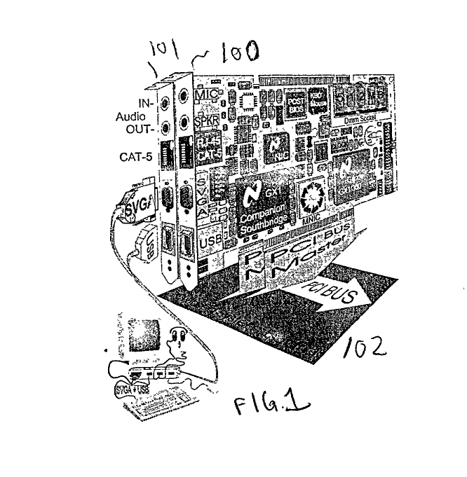

FIG. 1 depicts a diagram of two single board computers (SBC) shown for connection to a PC bus 102. Each SBC 100 to 101 may communicate with other peripherals such as modem cards, additional memory cards, or other standard computer resources which may be connected to (PC) bus 102 in a conventional fashion.

Notably, since plural PCs are connected to the PC bus as well, the bus functions as a local area network between the computers as well. For example, the bus may implement a standard inter computer network protocol such as TCP/IP, or NETBUI, or any other desired protocol. The chips for implementing these protocols are widely available and may be implemented on any one of the plural SBCs 100 to 101.

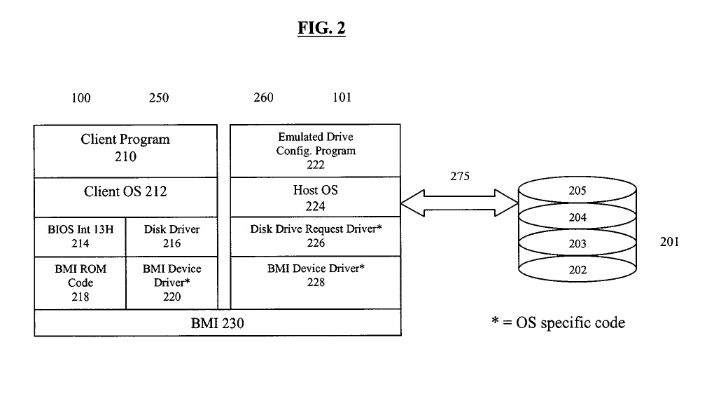

Preferably, none of the SBCs 100 to 101 contain their own local physical hard disk. Instead, one or more computers connected to the bus may contain such a disk. In accordance with a preferred embodiment of the present invention, each of the plural SBCs may utilize a portion of the physical disk connected to one of the SBCs. FIG. 2 shows a software architecture for accomplishing the same and more specifically, for facilitating the loading and operation of various programs as well as the device drivers and the operating system itself, from a physical disk to one or more other computers utilizing that disk.

The arrangement of FIG. 2 shows functional architectures 250 and 260 of 2 SBCs 100 and 101. In the example depicted in FIG. 2, the architecture 260 includes a physical disk associated therewith, and is thus termed a host. SBC 100, having no disk, is termed a client. Architecture 250 represents the functional architecture of an SBC with no physical disk connected thereto. In other embodiments, one or more hosts may be configured with plural diskless PCs. However, for purposes of simplicity herein, we use only one host 101 and one client 100.

When the SBC 100 is initially turned on, it must go through steps required in order to load its operating system and device drivers into memory for proper operation of client application programs.

BIOS command INT 13h, shown at 214, is a conventional command including parameters for loading an initial operating system loader into the memory of a computer. In accordance with the present invention, the BIOS command 214 is modified such that its parameters do not point to a physical location of a disk as in a conventional loading of an operating system. Instead, the parameters of BIOS command 214 are modified such that they are sent to the bus master interface (BMI) which sends the commands to the host computer. The BMI ROM code 218 is used before any device drivers are loaded and in place of such device drivers in order to provide for the BIOS command 214 to be conveyed to host 101 over BMI 230.

Notably, prior to the client initiating the process of booting itself and loading the operating system, the host system has already been booted and configured. We discuss now the architecture 260 of host SBC 101 which includes a physical drive. Emulated drive configuration program 222 contains the parameters for logically dividing hard disk 201 into plural disks, one to service each of the SBC's that may be connected to the host SBC 101 through the BMI 230. Host operating system 224 is a conventional operating system for accessing disk 201 and for providing input output services and other operating system services in accordance with known techniques in the art.

The disk drive request driver 226 serves to translate commands received from the BMI driver 228 to the appropriate commands to control and access the disk 201.

The BMI device driver allows the operating system 224 to communicate over BMI 230 with other SBC's as well as peripheral devices.

When the SBC 100 initially boots, the BIOS command 214 is conveyed by BMI ROM code over the BMI 230 and is received by BMI device driver 228. The command is then translated by device driver 228 and processed through host OS 224 as a simple input/output (I/O) request to the disk 201 for the reading of information. Preferably, the host 224 need not distinguish between input/output requests from applications programs running on any of a variety of different computers, operating system commands, or other commands. Rather, the host operating system 224 simply obtains the appropriate information from a portion 205 of the disk 201 which has been allocated as being associated with SBC 100, and forwards the information back over BMI 230.

Once the OS loader is received through BMI ROM code 218, it is stored in memory (not shown) of SBC 100 and executed to load the remainder of the operating system. The processing of the second request (i.e., the loading of the remainder of the operating system) is done in a similar manner as previously described, with the BIOS 214 command utilized with different parameters to cause the host OS 224 to load the client's operating system 212 into the memory of SBC 100.

After the second request, the client OS 212 is fully loaded and the BIOS and BMI ROM code 214 and 218 may no longer be needed. Instead, the client OS 212 may utilize its own drivers 216 and 220 in order to interface with BMI 230 to produce the appropriate commands to access the disk 201 as if it were a locally located disk at SBC 100.

Notably, the commands and data traveling across BMI 230 may be inter computer commands or may be commands between a computer and peripherals associated with such computer. The host OS 224 need not distinguish between the two because it can read and write from and to disk 201 without any regard for the substantive nature of the data.

It is also noted that the client OS 212 and host OS 224 need not be identical or even compatible. Each SBC 100 and 101 contains the appropriate drivers for interfacing between its associated OS 212 or 224, and BMI 230. Accordingly, it is possible that numerous computers and SBC's may be arranged in a hierarchical fashion. More specifically, FIG. 2 shows that link 275 allows the host operating system to access the physical disk 201. It is possible that the link may in fact be an additional link across BMI 230 and may represent a virtual disk which is physically present on yet another SBC.

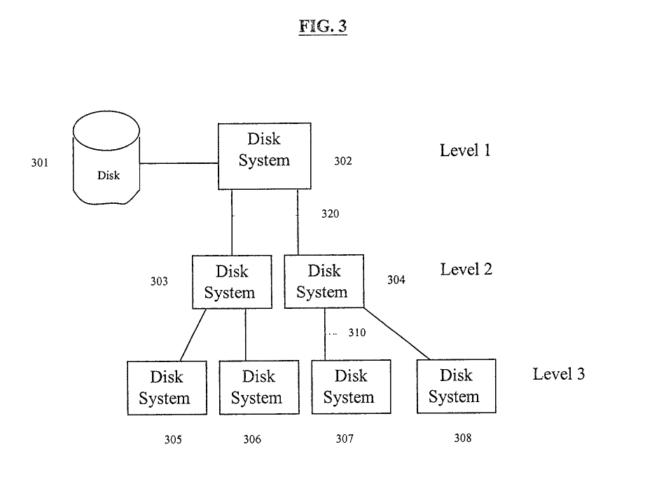

FIG. 3 shows such a hierarchical arrangement utilizing the teachings of the present invention. A plurality of SBCs 305-308 communicate over a BMI interface 310 with “host” SBCs 303-304. However, disk 201 of FIG. 2 is replaced with an additional BMI device driver which communicates over a bus 320 with still another SBC having a physical storage media 301. Thus, each diskless SBC “fools” its operating system and applications software into believing a local hard disk exists, but data is actually being obtained over a bus from a remote location.

It is noted that the levels of the hierarchy should be booted in order, so that the appropriate drivers and software are operational when a diskless system attempts to boot from a previous level in the hierarchy. Thus, in FIG. 3, SBC 302 should boot first utilizing its own ROM code and its physical storage media 301. Thereafter, diskless SBCs 303 and 304 boot from SBC 302, and thereafter, SBCs 305-308 boot from diskless SBCs 303 and 304 as shown in FIG. 3.

By sequencing the order in which the SBCs boot correctly, each SBC will boot from an already active SBC, and thus, will have available the resources it needs. More specifically, an “immediate subsequent” level is the level of the hierarchy that acts directly as a client for the host in question. Thus, by way of example, the level comprised of SBCs 303 and 304 is immediately to the level comprised of SBC 302, and the level comprised of SBCs 305-308 is immediately subsequent to the level comprised of SBCs 303-304. Accordingly, during initialization and bootup, it is preferred to boot level 1 (SBC 302) then level 2 (SBCs 303-304) and then level 3 (SBCs 305-308) in that order. By doing do, each computer that is booting from remote disk will not boot until all of the levels between the booting computer and the actual physical storage medium have booted. This assures that all levels may boot.

While the above describes the preferred embodiment of the invention, various modifications or additions will be apparent to those of skill in the art. Such modifications are intended to be covered by the following claims.

What is claimed:

1. A computer system comprising:
at least one client computer;
at least one host computer, the client computer and host computer utilizing a common physical disk storage medium, the physical storage medium storing an operating system for booting the client; and
first software stored on said client for causing said client, upon initialization, to load said operating system, boot said client, and cause said client to direct requests for disk access through said host computer.

2. The computer system of claim 1 wherein said first, software causes said client to load a driver onto said client, and wherein said driver directs requests for disk access from said client through said host.

3. The computer system of claim 2 wherein said first software comprises code stored in nonvolatile storage for causing a loader to load from said storage medium onto said client, and wherein said loader then causes said at least one driver to load onto said client.

4. The system of claim 2 wherein said physical storage medium is divided into plural sections, each sections being associated with and utilized by a different client computer.

5. The system of claim 2 wherein said host computer comprises a drive configuration program for allocating sections of said physical storage medium to each store an operating system for use by a separate client computer.

6. The system of claim 3 wherein the configuration program also restricts and manages access to the storage medium.

7. A method of booting a diskless computer comprising the steps of:
storing, in memory of said diskless computer, code sufficient to redirect a command to load an operating system loader to a physical storage medium of a second computer; and
upon initialization, executing said stored code in order to obtain an operating system loader from said storage medium.

8. The method of claim 7 further comprising the step of loading drivers onto said diskless computer to cause subsequent requests for disk access to be redirected over a bus to said second computer.

9. The method of claim 8 further comprising the step installing plural diskless computers within a cabinet to communicate over a common bus, and reserving a portion of said storage medium for each of said diskless computers.

10. The method of claim 8 further comprising reserving a portion of said physical storage medium for each of a plurality of client computer systems.

11. The method of claim 8 wherein said second computer and said diskless computer operate using different operating systems.

12. The method of claim 8 wherein said second computer and said diskless computer operate using a common operating system.

13. A computer system comprising a plurality of diskless computers and a physical storage medium, the physical storage medium being logically divided into plural sections, each section corresponding to a separate one of said diskless computers, each storage section having an operating system loader and an operating system stored thereon, and wherein each diskless computer is configured such that upon boot up, the operating system loader from a section corresponding to said diskless computer is first loaded, then the operating system so corresponding is loaded, and wherein said operating system includes drivers for directing disk access requests to and from said physical storage medium.

14. The computer system of claim 13 wherein said diskless computers communicate over a network, and wherein at least one of said diskless computers communicates with a peripheral device over a computer bus, and wherein said computer bus and said network utilize the same physical transmission medium.

15. The computer system of claim 14 wherein the computer bus and the network utilize different communications protocols.

16. A method of booting a series of computers from at least one operating system located on a storage medium, the method comprising:
organizing the computers into a hierarchy having a plurality of levels;
booting the computers in each level before booting the computers in another level immediately subsequent to said each level.

17. The method of claim 16 wherein the levels include a first level that comprises only one computer.

18. The method of claim 17 wherein, said booting step comprises first loading an operating system loader, and then loading an operating system.

19. The method of claim 18 wherein each level has less computers than the immediate subsequent level.
